(19) United States
(12) Patent Application Publication
(10) Pub. No.: US 2024/0157444 A1
(43) Pub. Date: May 16, 2024

(54) Extremely High-speed Laser Metal Deposition Process

(71) Applicant: Fraunhofer-Gesellschaft zur Förderung der angewandten Forschung e.V., Munchen (DE)

(72) Inventors: Thomas Schopphoven, Aachen (DE); Andres Gasser, Aachen (DE); Norbert Pirch, Aachen (DE); Matthias Brucki, Aachen (DE)

(21) Appl. No.: 18/550,654

(22) PCT Filed: Mar. 8, 2022
(86) PCT No.: PCT/EP2022/055800

§ 371 Date: Sep. 14, 2023

(30) Foreign Application Priority Data
Mar. 16, 2021 (DE) 102021106316.7

(51) Int. Cl. B22F 10/25; B22F 10/36; B22F 12/53; B23K 26/144; B23K 26/342; B33Y 10/00; B33Y 30/00

(52) U.S. Cl. CPC B22F 10/25; B22F 10/36; B22F 12/53; B23K 26/144; B23K 26/342; B33Y 10/00; B33Y 30/00; B22F 2998/10

(57) ABSTRACT

A laser metal deposition process is disclosed for carrying out laser metal deposition, whereby the component is metallurgically bonded to partially molten filler material by means of a laser beam directed onto a surface of a component, whereby the filler material is delivered into the laser beam as a powder jet of particles, whereby the particles absorb optical energy from the laser beam in a beam-particle interaction zone at a distance (A) from the surface of the component as a function of process parameters (P) of the laser metal deposition process and of the grain fraction and material properties of the particles and are applied to the surface of the component, whereby the process parameters (P) are adjusted such that at least a proportion of the particles reach the boiling temperature (S) along their trajectory through the laser radiation.

### SCOPE OF INVENTION

The invention relates to a laser metal deposition process for performing laser metal deposition in order to produce a metallurgical bond between an at least partially molten filler material and a surface of a component by means of laser radiation, which enables further increased extreme processing speeds. The invention further relates to a corresponding laser metal deposition apparatus and a component modified by this process or apparatus.

### BACKGROUND OF THE INVENTION

In state-of-the-art technology, laser metal deposition is known as a surface treatment process and for the additive manufacturing of components with the help of filler materials. In familiar forms of laser metal deposition, a filler material in powder form is introduced at a defined angle into a melt pool generated by a laser beam on a surface of a component by means of a powder nozzle. A schematic diagram in FIG. 1 shows the familiar process. A layer (2) of the filler material is produced on a component (1) by the supply of filler material (5) in the form of powdered particles to a melt pool (4) by means of a powder feed (3). The melt pool (4) is kept in the liquid state by irradiation of a laser beam (6). Filler material (5) in the form of solid powder arrives in the area of the melt pool (4) and is melted there by the laser beam (6) and the heating of the surrounding melt pool. If the component (1) is now moved relative to the laser (6) and the powder supply (3), the material of the melt pool moves out of the area of influence of the laser (6) and solidifies as a metallurgical bond between the base material and the filler material to form a layer (2). Seen in the laser incident direction x below the melt pool (4), the power irradiated by the laser (6) also partially penetrates the surface of the component (1). As a result of the action of the laser radiation, a heat-affected zone (10) is formed as a function of the duration of interaction. Depending on the radiation intensity and the duration of action of the laser (6), mixing of the filler material and the component material therefore takes place. The powder of the filler material can be injected laterally or coaxially into the melt pool. FIG. 1 shows lateral injection. The state-of-the-art process typically allows process speeds, i.e., feed rates of the component relative to the laser beam, of between 0.2 m/min and 5 m/min to be achieved.

An Extreme High-speed Laser Application process (EHLA) is already known from German patent application DE 10 2011 100 456 A1. In this process, the filler material is delivered to the melt pool in completely molten form. For this purpose, the powder particles are melted at a distance greater than zero from the melt pool and fed to the melt in a liquid state. The process according to the invention feeds the filler material to the melt pool in the same state of aggregation as the melt pool on the surface of the component. This eliminates the time required to melt the powder particles in the melt pool. This in turn reduces the time required for layer formation, which allows the process speed to be increased significantly. The powdered filler material is melted by the laser beam before it enters the melt pool generated by the laser beam. The achievable feed rate depends on the time required to melt the particles of the added powder, as well as on the time required to generate a melt pool on the surface of the component. It would be desirable to minimize both the heating up of the component and the degree of blending that occurs on the surface of the component. A further increase in the process speed would also be desirable.

### SUMMARY OF THE INVENTION

The object of the present invention is to provide a process for laser metal deposition at high feed and deposition rates, which allows low heat input into the component and low blending on the surface of the component.

According to the invention, this challenge is solved by a laser metal deposition process for carrying out laser metal deposition, whereby the component is metallurgically bonded to partially molten filler material by means of a laser beam directed onto a surface of a component, whereby the filler material is delivered to the laser beam as a powder jet of particles, whereby the particles absorb optical energy from the laser beam in a beam-particle interaction zone at a distance from the surface of the component as a function of the process parameters of the laser metal deposition and of the grain fraction and material properties of the particles and are applied to the surface of the component, whereby the process parameters are adjusted such that at least a proportion of the particles reach boiling point along their trajectory through the laser beam and, as a result of vapor pressure, the velocity of at least the proportion of the particles in the direction of the surface of the component is increased.

The laser metal deposition process is used to carry out laser metal deposition, i.e., to produce a metallurgical bond between a filler material and the surface of the component. Melting is the phase transition of a solid material or solid material mixture into the liquid state of aggregation. In laser metal deposition, the phase transition is usually achieved at a constant pressure by heat input from the laser beam. If a pure substance is melted at a constant pressure, the melting temperature present during this process can be unambiguously determined. During the phase transition, the temperature remains constant, and all heat supplied is applied as enthalpy of fusion in the change of state of aggregation. The inventors have recognized that the generation of a melt in a welding spot on the surface of the component prior to contact with the molten particles of the filler material is not a necessary prerequisite for the production of metallurgically bonded layers. In this case, the location where the laser radiation and the filler material meet the surface of the component is referred to as the weld spot, i.e., the location where deposition welding occurs.

The powder particles are at least partially melted by the laser beam before it strikes the surface of the component. The powder particles shade the laser beam such that only a part of the laser beam is transmitted through the powder and strikes the component. The surface of the component only needs to be preheated by the transmitted radiation component to such an extent that the additional energy input of the molten powder particles is sufficient to form a molten metallurgical bond at the surface due to the temperature increase resulting from the thermal contact, even with a previously solid, not yet molten substrate. For this purpose, it is advantageous to introduce as much energy as possible into the surface of the component via the particles striking the component, which means that the particles should be heated to as high a temperature as possible. The highest possible temperature in this case refers to a temperature as high as the boiling temperature of the particles. When a particle is heated to such a temperature, part of the particles or part of the surface of the particle in question is heated to its boiling temperature. Since a lower laser power is required to heat the surface of the particles of the filler material of at least part of the supplied powdered filler material at least partially to the boiling temperature of the filler material compared to the known state-of-the-art processes, with otherwise identical prerequisites, such as transmission factor, particle heating, etc., the achievable feed rate can be further increased and the previous process limit can be overcome. With the same laser power introduced, it takes longer to melt the weld spot on the surface of the component than to heat powder particles to their boiling temperature. Furthermore, the process according to the invention can be used to minimize the heat penetration depth and thus the heat-affected zone on the surface of the component, which means that the properties of the component, for example, in terms of mechanical properties such as ductility, Young's modulus, and/or yield stress, do not change or do not change significantly as a result of the deposition, even at its surface. Due to the low heat penetration depth, there is little blending of the filler material with the original material of the component, i.e., complete mixing of both materials on the surface of the component.

The increase in particle velocity according to the invention is advantageous in this respect because particles with high velocity in the case of particle temperatures greater than the melting temperature are deformed or pressed against the surface of the component as a result of the kinetic energy, even at a high feed rate along the surface of the component, which improves the transfer of heat to the surface. This can initiate good heat exchange of the particles with the solid substrate surface (of the component). As a result, an improved metallurgical bond is achieved. Any increase in the velocity of the particles toward the surface of the component is therefore beneficial for the process of laser metal deposition, especially in terms of enabling this process to operate at the highest possible feed rates. In one form of implementation, the velocity increase of the proportion of particles that have reached boiling temperature is greater than 2%. At and above a 2% increase in speed, the beneficial effect is clearly measurable in the treated component and higher feed rates can be achieved with simultaneously good-quality laser metal deposition and low blending compared to the current state of the art.

In this context, the surface of a component refers to the surface that faces toward the laser radiation and the powder jet, whereby this surface is only subjected to laser metal deposition where the filler material is applied to the surface. The phrase “applied to the surface of the component” used in this document refers to any method of applying one material to another material, in this case, the component. Specifically, for example, the powdered filler material can be melted in a laser beam before striking the component and blown (applied) onto it in molten form.

A laser beam is usually focused using single-lens or multi-lens laser optics, whose most important optical parameters are the focal length and the aperture (diameter of the free aperture). The laser beam is bundled by the laser optics. The beam waist created by bundling a laser beam after the laser optics is also called the beam focus. In practice, this beam focus is not a single discrete point but forms a focus area. Laser beams are electromagnetic waves characterized by a combination of high intensity, often very narrow frequency range (monochromatic light), sharp bundling of the beam, and a large coherence length. Laser beams from the infrared spectrum, for example, are used for laser metal deposition.

The term “filler material” refers to the totality of the material applied as a powder jet to the surface of the component. Thus, the filler material can be a single material or a mixture of materials, which can comprise a homogeneous, inhomogeneous, spatially, and/or temporally varying composition. For example, a filler material in the context of this invention also refers to a multi-material mix such as IN625 with WC. In this case, the filler material is present in the form of particles that are transported in a powder jet (or particle jet) in the direction of and through the laser beam onto the surface of the component, for example, with the aid of a transport gas stream that guides the particles to the component.

The term “grain fraction” refers to the particles with a certain size or a size distribution of particles within a total quantity of particles. For example, the particles may have sizes in a certain interval of particle sizes. As used in this document, the term “powder” or “powdered filler material” refers to a very finely reduced substance with an average particle size of less than 100 μm.

The term “beam-particle interaction zone” refers to the physical area above the surface of the component in which the particles absorb optical energy from the laser beam. The size of the beam-particle interaction zone depends on the process parameters, in particular, the laser beam guidance and the particle beam guidance.

The process parameters refer to all conditions for the laser metal deposition process that can be adjusted or are specified by the respective selected components. The process parameters determine, among other things, the beam-particle interaction zone and the number of particles that reach the boiling temperature in the beam-particle interaction zone, and the proportion of the material of the individual particles that is heated to the boiling temperature, which results in the increase in speed for the individual particles. The trajectory describes the flight path of the particles on their way to the surface of the component. This trajectory can be straight or curved, depending on how the particles interact with each other (e.g., by a mechanical impact) and with the laser radiation (thermally), particularly whether the particles are accelerated and how high this acceleration is. In one form of implementation, the process parameters to be set for this include one or more elements from the group laser power of the laser beam, beam guidance of the laser beam, size of the focus area, relative position of a powder jet focus to the laser beam, preferably to the focus area of the laser beam, density of the particles in the powder jet, velocity of the particles in the powder jet before reaching the laser beam, preferably the focus area of the laser beam, distance between laser focus and surface of the component, overlap and feed rate. The term ‘overlap’ in this context refers to the overlap of the powder jet with the laser beam, i.e., how many particles ultimately pass through the laser beam.

The vapor pressure that causes the velocity to increase is the result of heating a proportion of particles to boiling temperature. This causes material of the respective particle to evaporate, which exerts an impulse in the forward direction on the respective particle, pushing it toward the surface of the component and thereby accelerating this respective particle accordingly.

The process according to the invention thus provides a method for laser metal deposition for high feed and deposition rates, which allows low heat input into the component and low blending on the surface of the component.

The process according to the invention also represents a self-reinforcing process with regard to the thermalization of the optical energy in the powder jet of particles (heating of the particles in the laser beam) because the targeted use of the acceleration of particles as a result of the vapor pressure when the boiling temperature is reached on the particle surface means that the increased velocities of the particles lead to a dilution of the particle density in the focal area of the laser beam. As a result, the particles in this area with a temperature below the boiling temperature can absorb more optical energy from the laser beam due to the higher transmission factor. This is beneficial for the process because the more the ratio of thermalized optical energy shifts in favor of the powder jet of particles, the lower the penetration depth of the melt isotherms into the substrate. For the particles that have already been accelerated as a result of the vapor pressure when the boiling temperature is reached at the particle surface, a self-regulating behavior sets in as the accelerated particles experience reduced further heating. This is particularly advantageous for large powder densities or application rates and high feed rates.

In one form of implementation, the increase in velocity is so great that a constriction of the powder jet in the direction of the surface of the component is effected between 2% and 10%, preferably between 3% and 6%, particularly preferably between 4% and 5%, compared to a width of the non-illuminated powder jet.

In a further form of implementation, the proportion of particles that have reached the boiling temperature is greater than 5%, preferably greater than 30%, even more preferably greater than 50%, particularly preferably greater than 80% of the particles that are heated by the laser radiation along their trajectory. The more particles in the powder jet are accelerated in the direction of the surface of the component, the higher the feed rates that can be achieved with simultaneous high-quality laser metal deposition.

In a further form of implementation, at least 20%, preferably at least 30%, and particularly preferably at least 40% of a surface of the particles are heated to at least their boiling temperature. In the case of a spherical particle and a parallel incident laser beam bundle, no more than 50% of the surface can be heated to boiling temperature. Since the laser radiation in the laser metal deposition process according to the invention is focused and the particles can have a surface that deviates from the spherical shape, surface fractions greater than 50% would also be possible, but not significantly greater than 50%. The greater the proportion of the surface area of the particle that reaches the boiling temperature, the greater the increase in velocity of the particle in question. The more the individual particles in the powder jet are accelerated in the direction of the surface of the component, the higher the feed rates that can be achieved with simultaneous high-quality laser metal deposition.

In a further form of implementation, the particles have a mean particle size of ≥1 μm, preferably ≥10 μm, particularly preferably ≥30 μm and/or ≤100 μm, preferably ≤70 μm, particularly preferably ≤50 μm. The particle sizes mentioned have proven to be advantageous in terms of heating in the time available, homogeneity of the temperature distribution within the particle, the speed at which the particle temperature between its heating in the laser beam and its impact on the welding spot on the one hand, and the energy input possible by the individual particle on the surface of the component on the other.

In a further form of implementation, the surface of the component in an area on which the laser metal deposition is performed is itself heated by the transmitting laser beam to a temperature below its melting temperature, whereby at least at the point of impact of the particles on the surface of the component, the molten particles with a particle temperature greater than the melting temperature of the component at its surface induce a temperature above the solidus temperature in the surface of the component to produce the metallurgical bond. The laser beam is directed to the area of the surface of the component on which the deposition is carried out. However, the powdered filler material is passed through the laser beam before it impinges on the component. As a result, the laser beam is partially obscured. Depending on the density of the powder jet through the laser beam, more or less of the laser beam is allowed to pass through the powder jet. In this context, this is referred to as the ‘transmission factor’. The transmission factor thus indicates how much laser radiation finds its way through the powder jet. According to the invention, the transmission factor is adjusted by the powder jet passing through the laser beam in such a way that the surface of the component is heated where the filler material is applied, but the heating remains below the melting temperature of the surface of the component. The heating of the welding spot makes it possible to melt the surface of the component at this point more quickly through the impact of the hot, molten powder particles. Preheating the surface of the component by means of laser radiation allows even greater feed rates to be achieved. The fact that the laser radiation does not heat the surface of the component to melting temperature minimizes the blending of component material with filler material.

In a further form of implementation, the density of the particles in the powder jet is adjusted and the laser power and caustic curve of the laser beam are dimensioned and aligned with the powder jet in such a way that the laser power impinging on the surface of the component is less than 85%, preferably less than 50%, particularly preferably less than 30%, especially preferably less than 10%, especially preferably less than 5% of the laser power before contact of the laser beam with the particles of the powder jet. At higher feed rates, the impinging fraction of the laser radiation can be larger to still ensure low blending. In other words, the powder density can be used to adjust the transmission factor of the laser radiation accordingly. The optimum transmission factor is also a function of the feed rate. In optics, the term ‘caustic curve’, also called focal line or focal surface, refers to an area in which light rays are tangents to an arc or curved surface. The arc limits the light space. The intensity increases toward the arc and drops off steeply there.

In a further form of implementation, the laser beam comprises a focal area whose average distance from the surface of the component is between 0.25 mm and 20.0 mm, preferably between 0.25 mm and 10.0 mm, more preferably between 0.25 mm and 5.0 mm, particularly preferably between 0.8 mm and 1.2 mm. As determined experimentally, the above-mentioned maximum values still yield useful coating results, although a smaller distance is advantageous. The focal area is the point of highest energy density. In practice, this is not a discrete point, but rather an area. Therefore, the distance is counted from the center of the focal area and thus represents an average distance. The values mentioned for the distance have proven to be advantageous because, at these values, on the one hand, sufficient time elapses before the particle hits the surface of the component, so that the heat introduced by the laser beam at a point is homogenized within the particle via heat equalization processes, and on the other hand, the overall temperature level has not yet decreased significantly due to heat exchange processes with the surroundings. The values for the expansion of this area can vary between different sets of parameters for the process parameters.

In a further form of implementation, the powder jet is fed to the focal area of the laser beam, preferably coaxially. The conical shape of the powder jet can be easily achieved, for example, through the use of a coaxial powder nozzle. Consequently, it has proven advantageous if the jet of powder of the filler material is delivered to the welding spot coaxially with the laser beam. The conical shape of the powder jet has proven to be advantageous. The tip of the cone should be as close as possible to the focus point of the laser beam, in particular within the above-mentioned limits.

In a further form of implementation, the powder jet has a powder mass that is greater than 1 g/l per conveyed total volume comprising the conveyed gas volume and particle volume. As a result, the shielding gas is not included in the balance. The specified minimum quantity of powder material restricts the transmission factor of the laser beam onto the component in an advantageous manner.

In a further form of implementation, the powder jet is fed to the laser beam by means of a coaxial nozzle as a conical powder jet, by means of a multi-jet nozzle, or by means of a rectangular nozzle.

In a further form of implementation, the filler material is applied to the surface of the component at a feed rate along the surface of the component of between 5 m/min and 1000 m/min, preferably thereby greater than 10 m/min, more preferably thereby greater than 21 m/min, still more preferably thereby greater than 50 m/min, particularly preferably thereby greater than 100 m/min, very particularly preferably thereby greater than 130 m/min, extremely preferably thereby greater than 150 m/min.

In a further form of implementation, the filler material comprises or consists of a nickel-based alloy, a cobalt-based alloy, an iron-based alloy, a titanium-based alloy, a copper-based alloy, an aluminum-based alloy, an iron-based material, and/or ceramics, or a mixture of the above alloys.

In a further form of implementation, the process parameters are selected so that, using these process parameters with an inactive powder jet and the laser beam with 35% laser power, preferably 50% laser power, particularly preferably 85% laser power, according to the process parameters, no melting of the surface of the component occurs in the area of the incident laser beam. The inactive powder jet refers to a process during which no powder jet is applied to the surface of the component. Consequently, the laser beam can reach the surface of the component without shading and with the full transmission factor. If this laser beam is directed onto the surface of the component in this case using 50% of its laser power compared to the actual laser metal deposition process, the surface of the component must not melt under these conditions. This ensures that this does not happen even at 100% of the laser power when the filler material is applied in the form of the powder jet. The verification of this critical parameter of ‘laser power’ ensures that this parameter is determined for successful laser metal deposition and large deposition speeds and deposition rates can be achieved with simultaneous low heat input into the component and low blending on the surface of the component using the verified parameter set.

The invention further relates to a laser metal deposition apparatus for producing a metallurgical bond between an at least partially molten filler material and a surface of a component, using at least one laser from which a laser beam directed onto the surface of the component is emitted, and at least one powder nozzle for generating a powder jet from the filler material, whereby the laser beam and the powder nozzle are designed and arranged in such a way that the powder jet of particles is delivered into the laser beam and the particles absorb optical energy from the laser beam in a beam-particle interaction zone at a distance from the surface of the component that is dependent on process parameters in the laser metal deposition process and on the grain fraction and material properties of the particles in order to be applied to the surface of the component, whereby the process parameters of the laser metal deposition apparatus are adjusted such that at least a proportion of the particles reach the boiling temperature along their trajectory through the laser radiation and, as a result of the subsequent vapor pressure, there is a velocity increase of at least the proportion of the particles toward the surface of the component. The components used, such as the laser, can be standard components used for laser metal deposition equipment.

The invention also relates to a component with a surface onto which a filler material is metallurgically applied using the laser metal deposition process according to the invention. The component according to the invention differs from components according to the current state of the art, e.g., in terms of a particularly small mixing zone between the material of the component and the applied filler material. The component to which the filler material is to be applied can be any component made of a material that is fundamentally suitable for laser metal deposition. At least the surface of the component to which the filler metal is applied must consist of this material. A qualified expert, for example, will be familiar with materials suitable for this purpose. The component can have any suitable geometric shape, provided that the surface is designed in such a way that the laser beam and/or the powder jet can reach the area of the surface of the component to which the filler material is to be applied.

It is understood that the above-described forms of implementation or features thereof may also be combined in any combinations deviating from the claims and the back-references thereto to provide solutions to the preceding challenge within the scope of this invention.

Furthermore, it is expressly pointed out that in the context of the present patent application, indefinite articles and numerical indications such as “one,” “two,” etc. are generally to be understood as “at least” specifications, i.e., as “at least one . . . ,” “at least two . . . ,” etc., unless it is implicit from the respective context or obvious to or technically imperative for the qualified expert that only “exactly one . . . ,” “exactly two . . . ,” etc. can be implied. Furthermore, all numerical indications as well as indications of process parameters and/or device parameters are to be understood in the technical sense, i.e., as having the usual tolerances. In addition, the explicit indication of the restriction “at least” or “at a minimum” or similar should not give rise to the assumption that the simple use of “one,” i.e., without the indication of “at least” or similar, means “exactly one.”

### BRIEF DESCRIPTION OF THE FIGURES

In addition, further features, effects, and advantages of the present invention are explained with reference to the accompanying drawing and the following description. Components that are at least essentially identical in terms of their function in the individual figures are marked here with the same reference signs, although the components do not have to be numbered and explained in all figures.

The drawings show:

FIG. 1: A schematic representation of a laser metal deposition process according to the state of the art;

FIG. 2: A schematic representation of one form of implementation of the laser metal deposition process according to the invention;

FIG. 3: A schematic representation of a particle in the beam-particle interaction zone of FIG. 2; and

FIG. 4: A form of implementation of the laser metal deposition apparatus according to the invention for producing a component with a filler material applied by the laser metal deposition process.

### IMPLEMENTATION EXAMPLES

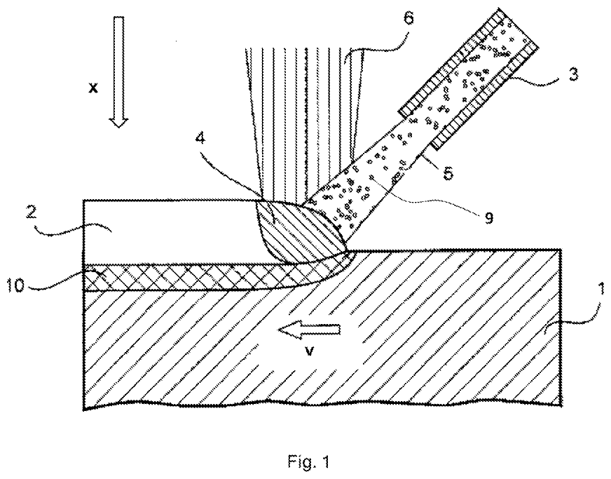

FIG. 1 is already described in the introduction to the description.

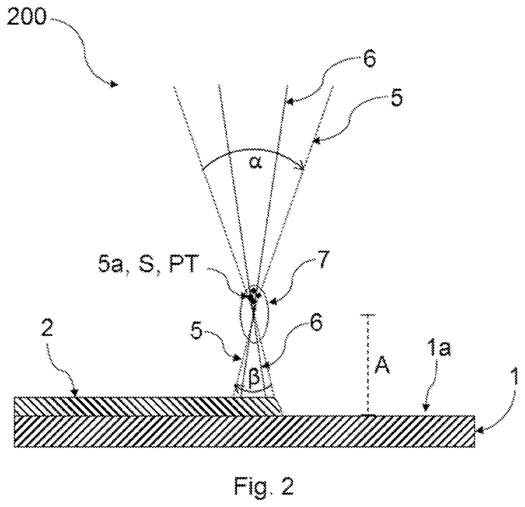

FIG. 2 shows a laser metal deposition process (200) according to the invention for carrying out laser metal deposition which uses a laser beam (6) directed at a surface (la) of a component (1) to metallurgically bond the component (1) with partially molten filler material. The filler material is fed here as a powder jet (5) of particles (5a) to the laser beam (6), whereby the particles (5a) absorb optical energy from the laser beam (6) in a beam-particle interaction zone at a distance (A) from the surface (1a) of the component (1) as a function of process parameters (P) of the laser metal deposition process (200) and of the grain fraction and material properties of the particles (5a) and are applied to the surface (la) of the component (1). In the illustrated configuration, the powder jet (5), which has a powder mass that can be greater than 1 g/l per total conveyed volume consisting of conveyed gas volume and particle volume, is coaxially fed to the focal area (7) of the laser beam (6). The powder jet (5) is fed to the laser beam (6) in this case as a conical powder jet by means of a coaxial nozzle. In another possible configuration, however, the powder can also be fed by means of a multi-jet nozzle or by means of a rectangular nozzle. The process parameters (P) are adjusted in such a way that at least a proportion of the particles (5a) reach the boiling temperature (S) along their trajectory through the laser radiation (6) and, due to a resulting vapor pressure, there is an increase in velocity of at least the proportion of the particles (5a) in the direction of the surface (1a) of the component (1), whereby the proportion of particles (5a) which have reached the boiling temperature (S) can be greater than 2%. The process parameters (P) to be set for this can include one or more elements from the group laser power of the laser beam (6), beam guidance of the laser beam (6), size of the focal area (7), relative position of a powder jet focus to the laser beam, preferably to the focal area (7) of the laser beam (6), density of the particles (5a) in the powder jet (5), velocity of the particles (5a) in the powder jet (5) before reaching the laser beam (6), preferably the focal area (7) of the laser beam, distance between laser focus and surface (1a) of the component (1), overlap and feed rate. The described increase in particle velocity can be so great in this case that a constriction of the powder jet (5) in the direction of the surface of the component is effected between 2% and 10%, preferably between 3% and 6%, particularly preferably between 4% and 5%, compared to a width of the non-illuminated powder jet (5). The constriction of the powder jet is defined by the percentage deviation of the angle α with respect to the angle β as follows: E=(α−β)/α [%]. According to the invention, the proportion of particles (5a) that are heated along their trajectory by the laser radiation and which have reached the boiling temperature (S) may be greater than 5%, preferably greater than 30%, more preferably greater than 50%, particularly preferably greater than 80% of the particles (5a). Furthermore, the surface of the component (1) in an area on which the laser metal deposition is performed can itself be heated by the transmitting laser beam (6) to a temperature below its melting temperature, whereby at least at the point of impact of the particles (5a) on the surface (1a) of the component (1), the molten particles (5a) with a particle temperature (PT) greater than the melting temperature of the component (1) at its surface (1a) induce a temperature above the solidus temperature in the surface (1a) of the component (1) to produce the metallurgical bond. Furthermore, the density of the particles (5a) in the powder jet (5) can be adjusted and the laser power and caustic curve of the laser beam (6) dimensioned and aligned with the powder jet (5) in such a way that the laser power impinging on the surface (1a) of the component (1) is less than 85%, preferably less than 50%, particularly preferably less than 30%, especially preferably less than 10%, especially preferably less than 5% of the laser power before contact of the laser beam (6) with the particles (5a) of the powder jet (5). The laser beam (6) can comprise a focal area (7) whose average distance (A) from the surface (1a) of the component (1) is between 0.25 mm and 20.0 mm, preferably between 0.25 mm and 10.0 mm, more preferably between 0.25 mm and 5.0 mm, particularly preferably between 0.8 mm and 1.2 mm. In this case, the filler material can be applied to the surface (1a) of the component (1) at a feed rate along the surface (1a) of the component (1) of between 5 m/min and 1000 m/min, preferably greater than 10 m/min, more preferably greater than 21 m/min, still more preferably greater than 50 m/min, particularly preferably greater than 100 m/min, very particularly preferably greater than 130 m/min, extremely preferably thereby greater than 150 m/min. According to the invention, the process parameters (P) of the laser metal deposition process (200) shown here can be selected so that, using these process parameters with an inactive powder jet (5) and the laser beam (6) with 35% laser power, preferably 50% laser power, particularly preferably 85% laser power, according to the process parameters (P), no melting of the surface (1a) of the component (1) occurs in the area of the incident laser beam.

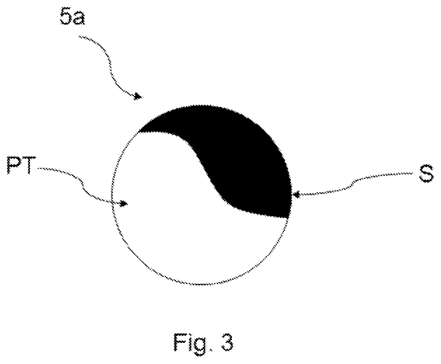

FIG. 3 shows a particle (5a) from the proportion of particles (5a) that have reached boiling temperature (S) along their trajectory through the laser radiation (6) and which is located within the beam-particle interaction zone according to FIG. 2. In the process, a surface of the particle (5a) is heated to approximately 40% of its boiling temperature (S). The remaining portion of the particle (5a) has a particle temperature (PT) less than the boiling temperature. Furthermore, the particle (5a) here has a mean particle size of ≥1 μm, preferably ≥10 μm, particularly preferably ≥30 μm and/or ≤100 μm, preferably ≤70 μm, particularly preferably ≤50 μm. The particle 5a of the filler material comprises or consists of, e.g., a nickel-based alloy, a cobalt-based alloy, an iron-based alloy, a titanium-based alloy, a copper-based alloy, an aluminum-based alloy, an iron-based material and/or ceramics, or a mixture of the above alloys.

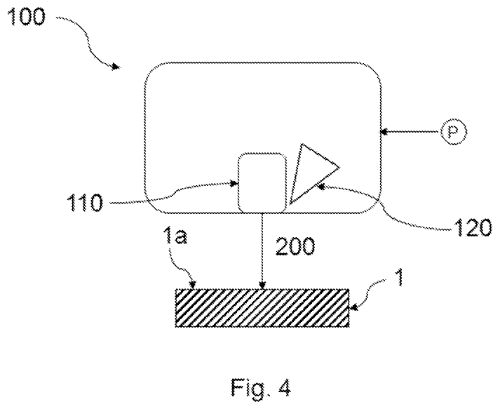

FIG. 4 shows a laser metal deposition apparatus (100) according to the invention for producing a metallurgical bond between an at least partially molten filler material and a surface (1a) of a component (1), having at least one laser (110) from which a laser beam (6) directed onto the surface (1a) of the component (1) is emitted, and having at least one powder nozzle (120) for generating a powder jet (5) from the filler material, whereby the laser beam (6) and powder nozzle (120) are designed and arranged in such a way that the powder jet (5) of particles (5a) is delivered into the laser beam (6) and the particles (5a) absorb optical energy from the laser beam (6) in a beam-particle interaction zone at a distance (A) from the surface (1a) of the component (1) as a function of process parameters (P) in the laser metal deposition process (200) and of the grain fraction and material properties of the particles (5a), in order to be applied to the surface (1a) of the component (1). The process parameters (P) of the laser metal deposition apparatus (100) can be adjusted in such a way that at least a proportion of the particles (5a) reach the boiling temperature (S) along their trajectory through the laser beam (6) and, due to resulting vapor pressure, there is an increase in velocity of at least the proportion of the particles (5a) in the direction of the surface (1a) of the component (1), resulting in the component (1) with a surface (1a) to which a filler material is applied by means of a laser metal deposition process. With respect to the reference symbols not shown here to which reference is made, we refer to FIGS. 2 and 3. Furthermore, it is pointed out that the arrangement of laser (110) and powder nozzle (120) shown here is intended purely for demonstrative purposes and does not imply any specific arrangement/configuration.

At this point, it should be noted that features of the solutions described above or in the claims and/or figures can also be combined, if necessary, in order to correspondingly and cumulatively implement or achieve the features, effects, and advantages described.

It is understood that the design variant example explained above is only an initial design variant of the present invention. In this respect, the design variant of the invention is not limited to this design variant example.

### LIST OF REFERENCE SYMBOLS

1 Component
1a Surface of the component
2 Layer
3 Powder feed
4 Melt pool
5 Powder jet
5a Particles
6 Laser beam, laser radiation
7 Focal area
9 Particles (according to the state of the art, FIG. 1)
10 Heat-affected zone
100 Laser metal deposition apparatus
110 Laser
120 Powder nozzle
200 Laser metal deposition process
A Distance between the focal area and surface of the component
PT Particle temperature
P Process parameters
S Boiling temperature
x Laser incident direction
v Feed rate (speed of the powder jet along the surface of the component or relative speed of the laser substrate)

1. A laser metal deposition process for carrying out laser metal deposition, whereby the component is metallurgically bonded to partially molten filler material by means of a laser beam directed onto a surface of a component, whereby the filler material is delivered into the laser beam as a powder jet of particles, whereby the particles absorb optical energy from the laser beam in a beam-particle interaction zone at a distance (A) from the surface of the component as a function of process parameters (P) of the laser metal deposition process and of the grain fraction and material properties of the particles and are applied to the surface of the component, characterized in that
the process parameters (P) are adjusted in such a way that at least a proportion of the particles reach the boiling temperature (S) along their trajectory through the laser radiation and, due to a resulting vapor pressure, there is an increase in velocity of at least the proportion of the particles in the direction of the surface of the component.

2. The laser metal deposition process according to claim 1, characterized in that
the velocity increase of the proportion of particles that have reached boiling temperature (S) is greater than 2%.

3. The laser metal deposition process according to claim 1, characterized in that
the increase in particle velocity is so great that a constriction of the powder jet in the direction of the surface of the component is effected between 2% and 10%, preferably between 3% and 6%, particularly preferably between 4% and 5%, compared to a width of the non-illuminated powder jet.

4. The laser metal deposition process according to claim 1,
characterized in that
the proportion of particles which have reached the boiling temperature (S) is greater than 5%, preferably greater than 30%, even more preferably greater than 50%, particularly preferably greater than 80% of the particles which are heated by the laser radiation along their trajectory.

5. The laser metal deposition process according to claim 1,
characterized in that
at least 20%, preferably at least 30%, and particularly preferably at least 40% of a surface of the particles are heated to at least their boiling temperature (S).

6. The laser metal deposition process according to claim 1,
characterized in that
the particles have a mean particle size of ≥1 μm, preferably ≥10 μm, particularly preferably ≥30 μm and/or ≤100 μm, preferably ≤70 μm, particularly preferably ≤50 μm.

7. The laser metal deposition process according to claim 1,
characterized in that
the surface of the component in an area on which the laser metal deposition is performed is itself heated by the transmitting laser beam to a temperature below its melting temperature, whereby at least at the point of impact of the particles on the surface of the component, the molten particles with a particle temperature (PT) greater than the melting temperature of the component at its surface induce a temperature above the solidus temperature in the surface of the component to produce the metallurgical bond.

8. The laser metal deposition process according to claim 1,
characterized in that
the density of the particles in the powder jet can be adjusted and the laser power and caustic curve of the laser beam dimensioned and aligned with the powder jet in such a way that the laser power impinging on the surface of the component is less than 85%, preferably less than 50%, particularly preferably less than 30%, especially preferably less than 10%, especially preferably less than 5% of the laser power before contact of the laser beam with the particles of the powder jet.

9. The laser metal deposition process according to claim 1,
characterized in that
the laser beam comprises a focal area whose average distance (A) from the surface of the component is between 0.25 mm and 20.0 mm, preferably between 0.25 mm and 10.0 mm, more preferably between 0.25 mm and 5.0 mm, particularly preferably between 0.8 mm and 1.2 mm.

10. The laser metal deposition process according to claim 9,
characterized in that
the powder jet is delivered to the focal area of the laser beam, preferably coaxially.

11. The laser metal deposition process according to claim 1,
characterized in that
the powder jet has a powder mass which is greater than 1 g/l per conveyed total volume comprising the conveyed gas volume and particle volume.

12. The laser metal deposition process according to claim 1,
characterized in that
the powder jet is delivered to the laser beam by means of a coaxial nozzle as a conical powder jet, by means of a multi-jet nozzle, or by means of a rectangular nozzle.

13. The laser metal deposition process according to claim 1, characterized in that
the filler material is applied to the surface of the component at a feed rate along the surface of the component of between 5 m/min and 1000 m/min, preferably greater than 10 m/min, more preferably greater than 21 m/min, still more preferably greater than 50 m/min, particularly preferably greater than 100 m/min, very particularly preferably greater than 130 m/min, extremely preferably greater than 150 m/min.

14. The laser metal deposition process according to claim 1,
characterized in that
the filler material comprises or consists of a nickel-based alloy, a cobalt-based alloy, an iron-based alloy, a titanium-based alloy, a copper-based alloy, an aluminum-based alloy, an iron-based material, and/or ceramics or a mixture of the above alloys.

15. The laser metal deposition process according to claim 1,
characterized in that
the process parameters (P) are selected so that, using these process parameters (P) with an inactive powder jet and the laser beam with 35% laser power, preferably 50% laser power, particularly preferably 85% laser power, according to the process parameters (P), no melting of the surface of the component occurs in the area of the incident laser beam.

16. The laser metal deposition process according to claim 1,
characterized in that
the process parameters (P) to be set for this include one or more elements from the group laser power of the laser beam, beam guidance of the laser beam, size of the focal area, relative position of a powder jet focus to the laser beam, preferably to the focal area of the laser beam, density of the particles in the powder jet, velocity of the particles in the powder jet before reaching the laser beam, preferably the focal area of the laser beam, distance between laser focus and surface of the component, overlap and feed rate.

17. A laser metal deposition apparatus for producing a metallurgical bond between an at least partially molten filler material and a surface of a component, having at least one laser, from which a laser beam directed onto the surface of the component is emitted, and having at least one powder nozzle for generating a powder jet from the filler material, whereby the laser beam and powder nozzle are designed and arranged in such a way that the powder jet of particles is delivered into the laser beam and the particles absorb optical energy from the laser beam in a beam-particle interaction zone at a distance (A) from the surface of the component as a function of process parameters (P) in the laser metal deposition process and of the grain fraction and material properties of the particles, in order to be applied to the surface of the component
characterized in that,
the process parameters (P) of the laser metal deposition apparatus are adjusted in such a way that at least a proportion of the particles reach the boiling temperature (S) along their trajectory through the laser radiation and, due to a resulting vapor pressure, there is an increase in velocity of at least the proportion of the particles in the direction of the surface of the component.

18. A component with a surface onto which a filler material is metallurgically applied using a laser metal deposition process according to claim 1.
